(19) United States
(12) Patent Application Publication
(10) Pub. No.: US 2016/0247131 A1
(43) Pub. Date: Aug. 25, 2016

(54) MONEY EXCHANGE SYSTEMS AND METHODS

(71) Applicants: Hernan Ahmed, Norco, CA (US); Francisco Javier Silva, Salt Lake City, UT (US)

(72) Inventors: Hernan Ahmed, Norco, CA (US); Francisco Javier Silva, Salt Lake City, UT (US)

(21) Appl. No.: 15/048,485

(22) Filed: Feb. 19, 2016

Related U.S. Application Data
(60) Provisional application No. 62/118,217, filed on Feb. 19, 2015.

(51) Int. Cl. G06Q 20/10; G06Q 30/02; G06Q 20/32; G06Q 20/40; G06Q 20/20

(52) U.S. Cl. CPC G06Q 20/108; G06Q 20/405; G06Q 20/209; G06Q 20/3223; G06Q 30/0279

(57) ABSTRACT

A system and method perform a financial transaction, and comprise processing a physical tradeable asset having a value that is greater than a value of the good or service being purchased with the financial instrument; and electronically depositing at a storage device change from the asset corresponding to a difference between the value of the physical tradable asset and the value of the good or service being purchased.

### RELATED APPLICATIONS

This application claims priority to U.S. Provisional Application Ser. No. 62/118,217, filed on Feb. 19, 2015 entitled “Money Exchange Systems and Methods”, the entirety of which is incorporated by reference herein.

### FIELD

The present inventive concepts relate to financial transactions, and particular, to a system and method that allows a purchaser to use currency to make a purchase, and to receive change in a different currency, such as digital currency or electronic bank deposit.

### BRIEF SUMMARY

Embodiments of the inventive concepts are directed to a system and method for converting physical currency to an electronic format, for example, digital currency that can be transmitted to a data storage device, bank website, and so on. A software application stored and executed at a computer such as a laptop computer, smartphone, or other electronic device, me be generated that allows a user to convert physical currency in any denomination (in any physical form, i.e. coin, paper, solid, liquid) into digital currency that is credited to an account, for example, private, personal, public, institutional, retirement, investment, credit card, mortgage, bitcoin, or related account known to those of ordinary skill in the art for receiving, processing, and maintaining transactions including the physical exchange, electronic exchange, or a combination thereof, with respect to currency. The concepts can also be claimed to be vice versa, so we should be able to convert from digital currency into physical currency. Related applications may also apply, for example, directing the change of money for goods/services exchange to a charity, donation, or other purpose.

The digital application will also have the ability to hold the digital currency in its own banking system, i.e., Paypal™ or Bitcoin™. The digital application of conversion should be applicable to all devices. A physical card, such as a debit card, gift card, membership card, identification card (for example, a military ID, student ID, and so on) that is associated to an account that can be used to collect currency or pay for goods and services. The physical card includes data that permits the card to function the same way as the digital application except for its physical form, which is preferable by many users. A machine that will collect currency (in any form), scan it for authenticity and generate a credit in digital or physical form of currency on the user's digital application or account, physical debit card, or issued physical card. The conversion machine is constructed and arranged to convert physical currency into electronic currency, or vice versa, by uploading information from an application executed on the user's electronic device or physical card to the machine.

In accordance with one aspect, a method for performing a financial transaction, comprises processing a physical tradeable asset having a value that is greater than a value of the good or service being purchased with the financial instrument; and electronically depositing at a storage device change from the asset corresponding to a difference between the value of the physical tradable asset and the value of the good or service being purchased.

In accordance with another aspect, a conversion machine comprises a money collection input for receiving a deposited amount of physical cash; a storage device for temporarily storing the received physical cash; and a conversion processor that converts a value of the received physical currency to a digital value.

In accordance with another aspect, a method for donation exchange comprises activating a change donation application at an electronic device having a display; activating a digital donation box; depositing physical cash into the digital donation box in response to an instruction displayed at the display of the digital donation box; processing at the digital donation box the received physical cash to determine a value of the received cash; displaying options at the digital donation box for donating the received physical cash; and providing the physical cash or an electronic equivalent of the physical cash to the selected donation recipient.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a flow diagram illustrating a currency exchange, in accordance with some embodiments.

FIG. 2 is a flow diagram illustrating a currency exchange, in accordance with some embodiments.

FIG. 3 is a flow diagram illustrating a currency exchange, in accordance with some embodiments.

FIG. 3A is a block diagram of a conversion machine, in accordance with some embodiments.

FIG. 3B is a network diagram of an environment in which embodiments may be practiced.

FIG. 4 is a flow diagram of a method for transferring change from a currency exchange to an electronic format, in accordance with some embodiments.

FIG. 5 is a view of an application user interface, in accordance with some embodiment.

FIG. 6 is a flow diagram of a method for transferring change from a currency exchange to an electronic format, in accordance with some embodiments.

FIG. 7 is a flow diagram of a method for transferring change from a currency exchange to an electronic format, in accordance with other embodiments.

FIG. 8 is a flow diagram of a method for transferring change from a currency exchange to an electronic format, in accordance with other embodiments.

FIG. 9 is a flow diagram of a method for transferring change from a currency exchange to an electronic format, in accordance with other embodiments.

FIG. 10 is a flow diagram illustrating a donation exchange, in accordance with some embodiments.

### DETAILED DESCRIPTION

Various exemplary embodiments will be described herein with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

It is well-known that the use of currency to purchase items of interest dates back to the beginning of human civilization. In modern times, the presence of electronic systems permit credit cards, debit cards, or the like permit consumers to be used purchase goods or services, where the money is provided by the bank or credit card company and either withdrawn automatically from a bank account or otherwise collected by well-known means from the purchaser.

With the advent of electronic devices such as personal computers, smartphones, and so on, debit and credit purchases can be made without a plastic card. For example, a user can purchase an item using a smart phone e-commerce application or related application stored at and executed by an electronic device, which establishes a digital transaction via the network between buyer, seller, and intermediary bank. The benefits of charge cards, electronic currency exchange, and the like has reduced the need for consumers to carry physical currency (i.e., government-backed notes and coins) for use in purchasing items.

Nevertheless, in a typical physical currency or “hard currency” exchange, a user may purchase an item in the form of a financial instrument, such as government-backed notes, for example, U.S. dollars. If the value of the physical currency, i.e., note such as a dollar bill, exceeds the purchase cost of the item, then the seller will provide change to the buyer in the form of coins and/or notes such as U.S. dollars. For example, a consumer may purchase a cup of coffee for 75 cents using cash. In doing so, the consumer provides the cashier with a dollar bill ($1.00). The cashier provides change (25 cents) to the consumer, for example, a quarter, two dimes and a nickel, and so on.

Features of the present inventive concepts provide a physical currency transfer to occur without the undesirable exchange of physical coins or banknotes such as dollar bills that would otherwise be present when a buyer receives change left over from the purchase. The systems and methods in accordance with embodiments may process tradable assets of any kind.

The buyer no longer needs to receive hard cash or currency such as pennies, nickels, dollar bills, etc. Instead, the change that the buyer is entitled to from receives “change” from a transaction in the form of an electronic transaction, i.e., the change is digitally transferred to the buyer's bank account at the time of purchase, or after the transaction has settled or closed. Although the seller is in possession of hard currency received from the buyer, the systems and methods are constructed so that the physical change that would otherwise be provided to the buyer in an exchange is in fact taken from the seller to prevent the seller from keeping the change and so that the buyer may instead receive change in an electronic format.

In some embodiments, when the buyer purchases an item and is entitled to physical change, there is a transaction code that is generated if the buyer decides to execute the conversion of physical currency to digital. In one example, the buyer pays $2.00 for a $1.75 item. The $2.00 can be in any physical form, gas, solid, liquid, dollars, bitcoin or nomination, or other asset having value. In doing so, the buyer executes an application, for example, on a mobile electronic device such as a smartphone, and this initiates a transaction code on the seller register. The scanning may be performed by a scanner provided by the merchant, or other device that scans a code or other data on a display of the smartphone so that the phone is read by the payment terminal. An NFC chip in the mobile electronic device can communicate with the merchant bank or acquiring (clearing) bank. The buyer is credited $0.25 by the merchant or (clearing bank) bank. According to some commerce laws, this may take up to 2-3 days to become available depending on the bank. The buyer's bank knows that the transaction is taking place when the NFC chip is read by the payment terminal. The phone app is connected with the buyer's banking information. The payment terminal sends a message to the buyer's bank that a transaction is taking place.

At the end of the day, the seller, e.g., store, e-commerce provider, and so on deposits money at the seller bank. The seller bank records all transactions and at that point it the seller bank can read the transaction where the $0.25 change must be debited from the seller account into the buyer account or associated account linked to the buyer's digital application or physical card. In another example, the buyer may receive the $0.25 change credited to the buyer's physical card, e.g., credit card, debit card, or the like at the time of purchase by the same means except that the change is credited to the buyers physical card linked to a bank account rather than the digital application.

An electronic transaction can potentially be processed in real-time or near real-time, thereby giving credit to the buyer from the seller immediately. However, a more likely transaction includes a delay, where the electronic transaction is credited within 2-3 business days, or other timeframe established by the financial institution participating in the transaction.

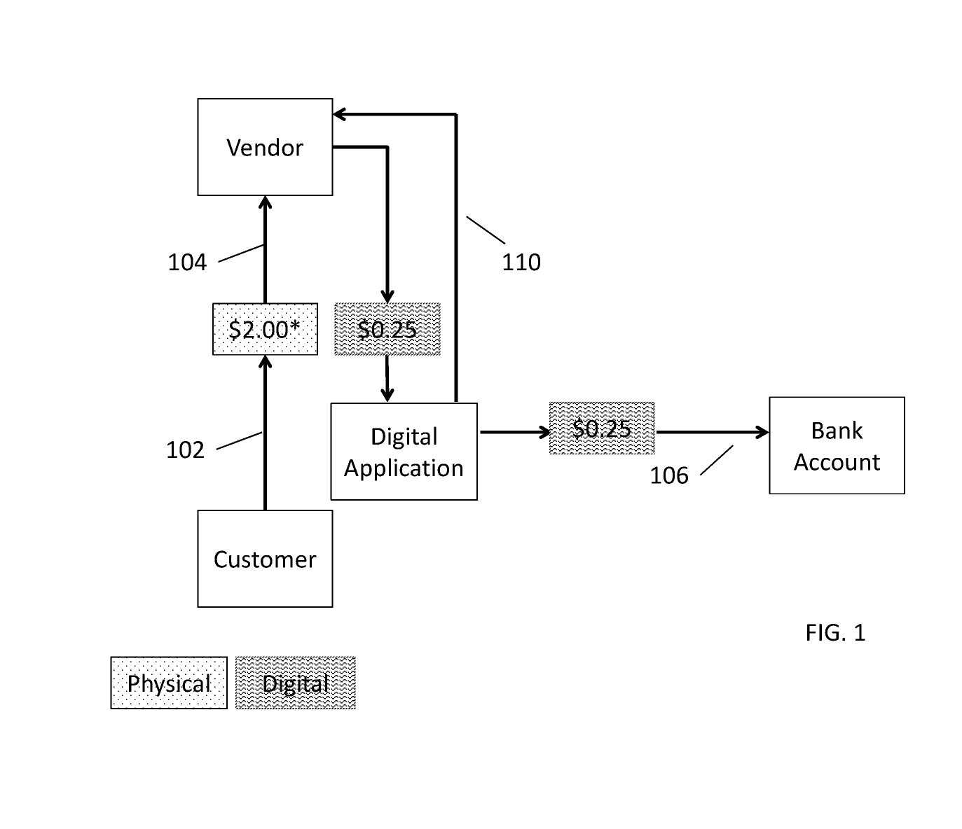

FIG. 1 is a flow diagram illustrating a currency exchange, in accordance with some embodiments.

In this example, a customer buys (102) a cup of coffee for $1.75, pays (104) the cashier $2.00 physical currency. An application is stored and executed on a computer. Instead of receiving $0.25 in physical change, the $0.25 is credited (106) to an electronic account, for example, the customer's bank account.

The digital application can also be used permitting the buyer to pay (110) for transactions using a smartphone application or the like.

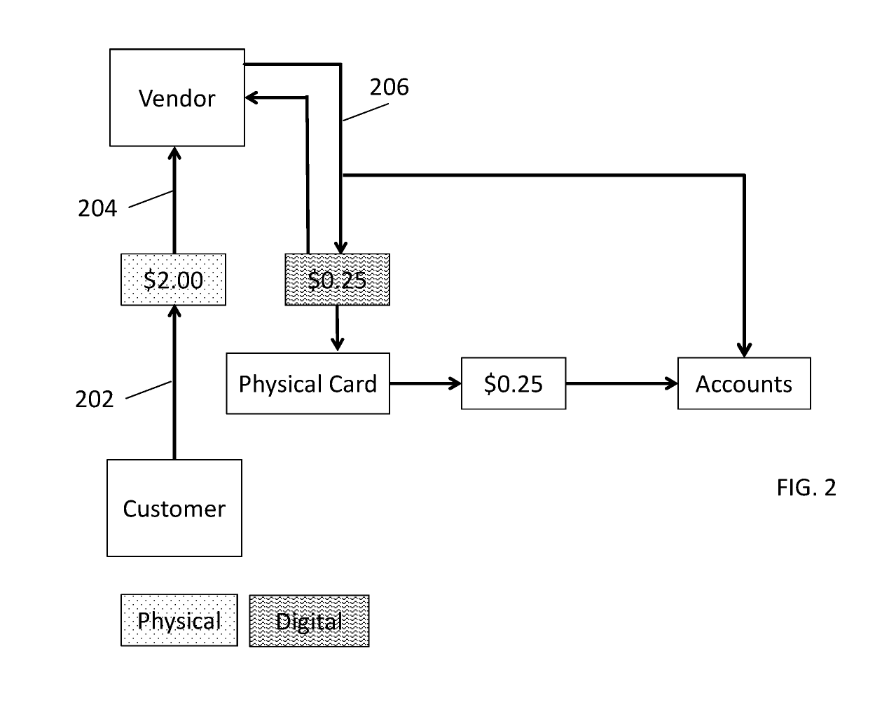

FIG. 2 is a flow diagram illustrating an exchange between elements of a currency exchange, in accordance with some embodiments.

In this example, the customer buys (202) a cup of coffee for $1.75, pays (204) the cashier $2.00 in physical currency. The customer instead of receiving $0.25 physical change is credited $0.25, where the credit is deposited (206) at a bank account, or applied to a credit card, debit card, or the like. The physical card can also be used to pay for transactions, as described herein. For example, the physical card may be a debit card or gift card or other bank-issued card that is credited with $0.25 and includes a magnetic strip, electronic chip, or the like that can be used to swipe the card at a sensor so that the customer may receive the credit. The merchant may credit the “change”. In doing so, the transaction is verified when the user swipes the card and a processor matches transaction IDs.

As shown in FIG. 2, there are several paths for currency to take when converting from the physical domain to a digital domain. In the previous example, the $0.25 in change may be provided from a physical card, for example, gift card or debit card, to an account, or provided from the merchant vendor to an account, for example, an online bank account. Other examples may equally apply where a buyer wants the merchant to refund his/her change and the buyer is unable to scan a mobile device the swiping of the card via the payment terminal can initiate a transaction between the merchant and the buyer.

In other embodiments, the foregoing can be performed in a same manner as applications where a buyer may return an item purchased at a store, and a store representative asks the buyer if the buyer wants a credit, where the seller can apply the credit to the card used to purchase to item being returned, and the seller credits the buyer the money. In accordance with the inventive concepts, the buyer exchanges physical currency to digital form on the buyer's credit or debit card instead of receiving physical change. In some embodiments, the inventive concept allows a buyer to buy something with cash, but to receive a return via digital credit. Here, there is no cash back it is refunded in the form of digital currency, when the payment terminal reads the user's mobile device or NFC chip. A hard receipt would be required in this case for the merchant to verify that there was a purchase using cash in the first place.

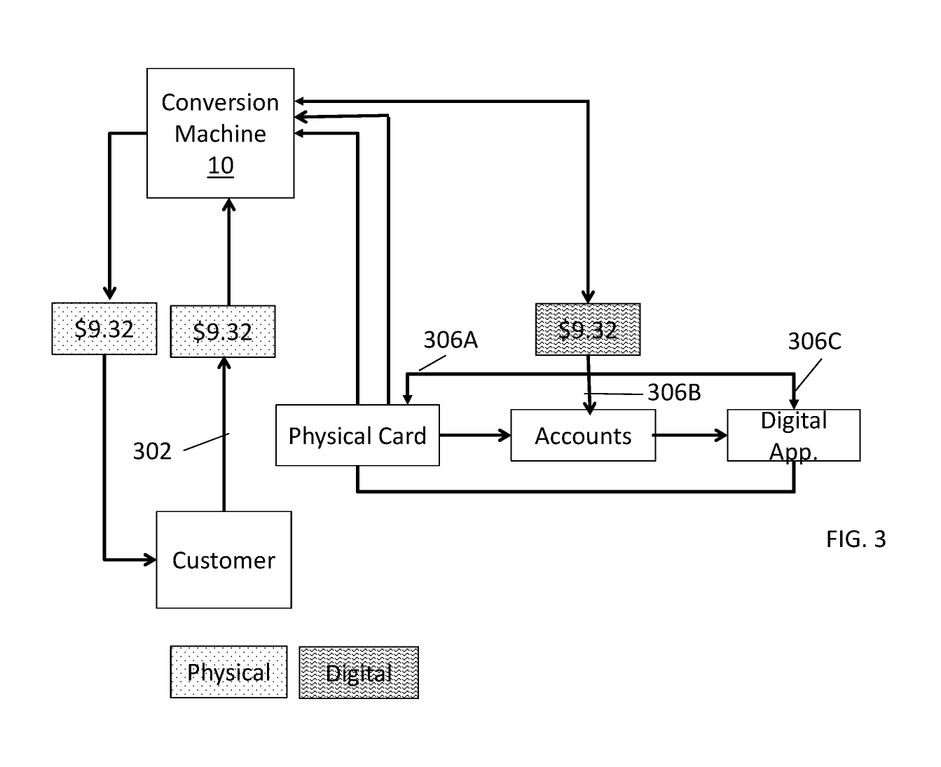

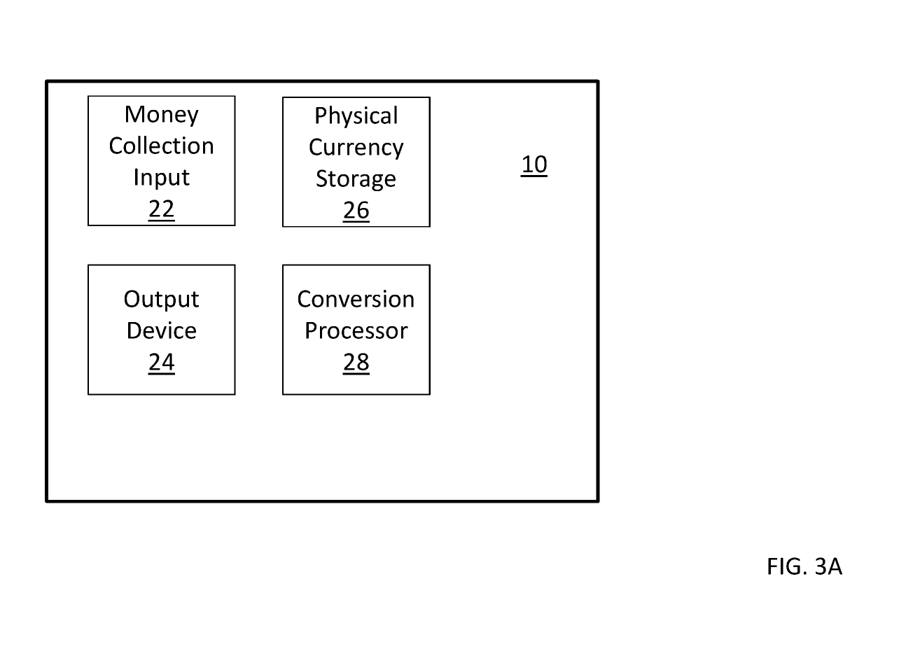

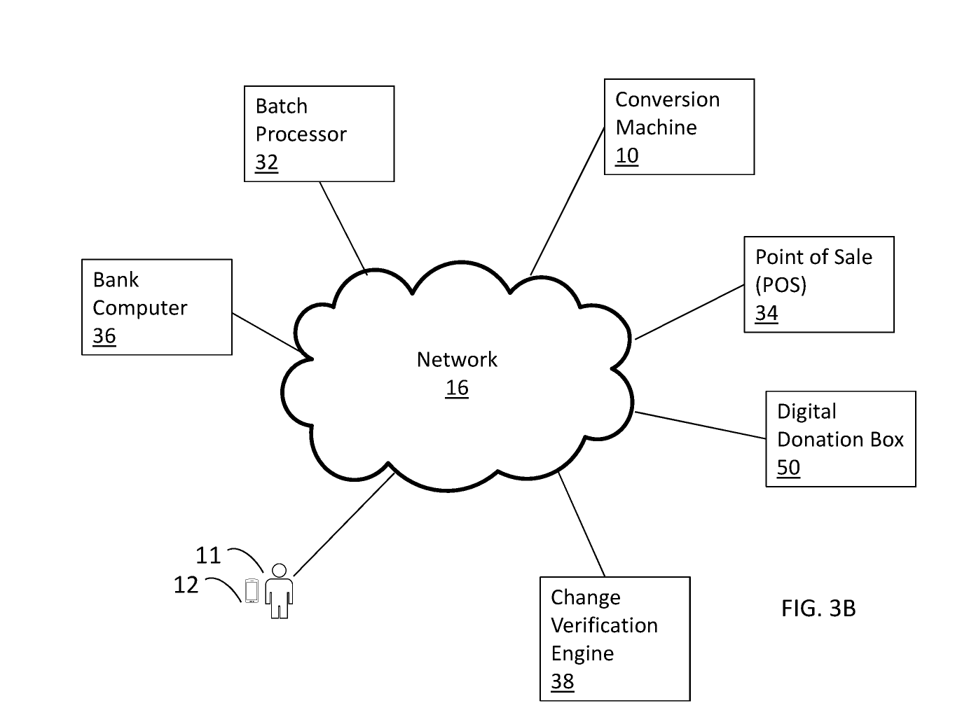

FIG. 3 is a flow diagram illustrating an exchange between elements of a currency exchange, in accordance with some embodiments.

In this example the customer deposits (302) an amount of physical currency, for example, $9.32, into a conversion machine 10. The conversion machine 10 converts $9.32 from physical money to digital money, which is deposited/credited (306) into an application, for example, a smartphone or mobile application (306C), or physical card (306A) such as a credit card, debit card, store or bank issued card, or an account (306B) such as a bank account. In some embodiments, the customer may carry a physical card, for example, include a magnetic strip or chip for storing and/or retrieving purchase data. Here, the card may store “electronic change” from various transactions described herein. All transactions can be reversible. The $9.32 represents physical currency, bitcoin, nomination, or any currency known to those of ordinary skill in the art.

FIG. 3A is a block diagram of a conversion machine 10, in accordance with some embodiments.

The conversion machine 10 may include a money collection input 22, an output device 24, a physical currency storage device 26, and a conversion processor 28. The input 22 receives the physical currency, for example, coins, dollar bills, etc., and stores it at the storage device 26 for subsequent retrieval. In this case we would receive the currency and we would directly credit the person depositing the funds into the conversion machine. After the funds are verified a debit is initiated between our bank or other banking system and credits the person who deposited the physical funds into their account via the use of physical card or mobile phone app. For example a person goes and deposits $100 of currency into the money conversion machine the person making the deposit inserts a physical card (bank card, credit card, gift card) and enters his PIN number the money conversion machine communicates with our servers and credits the depositor the currency after the deposited funds our verified.

The conversion processor 28 converts a value of the received physical currency to a digital value, which is output from the output device 24. For example, if $2.85 in cash is deposited, then the conversion processor 28 determines that the value of the cash is $2.85, and generates an electronic value that is stored.

FIG. 3B is a network diagram of an environment in which embodiments may be practiced. The environment may include a network 16 to which one or more of a batch processor 32, conversion machine 10, point of sale (POS) system 34, bank computer 36, change verification engine 38, and/or customer mobile electronic device 12 may communicate. Some or all of the batch processor 32, conversion machine 10, point of sale (POS) system 34, bank computer 36, change verification engine 38, and/or customer mobile electronic device 12 can be part of a same hardware platform. In other examples, as shown in FIG. 1 these elements are separate hardware devices and communicate with each other via a network 16. The network 16 may be a public switched telephone network (PSTN), a mobile communications network, a data network, such as a local area network (LAN) or wide area network (WAN), or a combination thereof, or other communication network known to those of ordinary skill in the art.

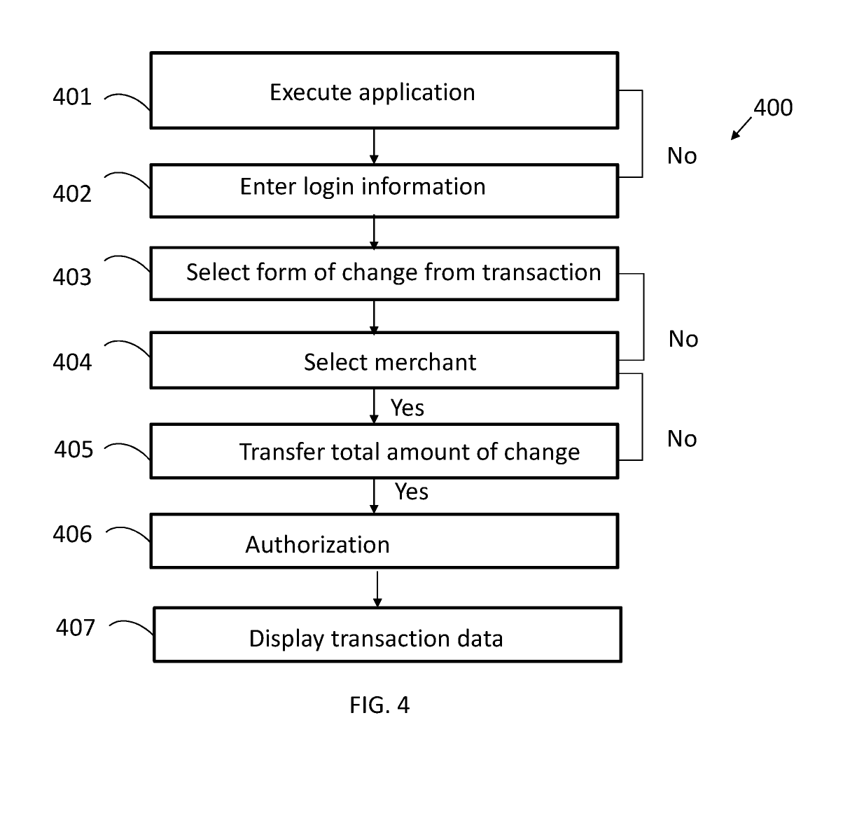

FIG. 4 is a flow diagram illustrating steps in a method 400 for transferring change from a currency exchange to an electronic format, in accordance with some embodiments. Some or all of the method 400 can be performed on the conversion machine 10 and/or other computer hardware.

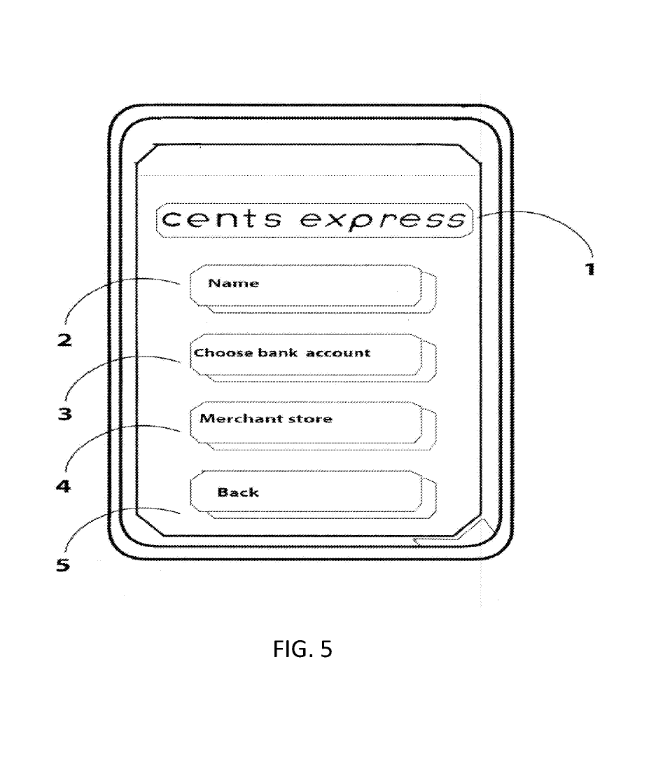

At block 401, an application is stored at a computer memory device and executed at a hardware processor, for example, on a mobile electronic device 12 illustrated at FIG. 3B. For example, as shown at FIG. 5, a user display can provide one or more windows that include a title, purchaser name, application serial number, or other relative information. When the application is executed, the internet or other communication network is used so that the application communicates with a server, for example, Apple I Beacon to allow the smartphone to execute an action when the smart phone is detected with other Bluetooth™ devices, for example, the merchant's register. The buyer or customer 11 enter the username and password on the application for security reasons, for example, to prevent others from stealing account information.

Referring again to the embodiment of the user display window illustrated at FIG. 5, the displayed title 1 of the application when touched can direct to another window showing the issue number and the version of the application, or other related information. The name 2 can refer to the name issued to the purchaser for use. When clicked, the password will display its place. After access is granted, the application will display at location 3 a list of financial institutions, e.g., banks, to choose form for communicate with the merchant. After a bank 3 is selected, the merchant store along with an identification number can be displayed to being the transaction, which will then lead to another interface. Back button 5 when selected permits the purchaser to choose to cancel the purchase or go back to previous selection.

Referring again to FIG. 4, at block 402, the buyer 11 enters login information, such as username, password, or related security information. An authorization/authentication process can be performed in a secure manner as is well-known to those of ordinary skill in the art.

At block 403, a display window may be presented at the user interface of the buyer's electronic device (i.e., smartphone, laptop computer, or other computer having a display). The display may provide a bank account to choose from for the currency transaction. The list of banks can be generated from a pay list application in communication with the buyer's smartphone application used to participate in the inventive electronic exchange.

At block 404, a merchant is selected at the user interface of the buyer's electronic device. A list of available merchants can be displayed. The merchants can be displayed according to location relative to the buyer, for example, established by the global positioning system (GPS) of the buyer's electronic device. A display window can provide an option for the merchant access to the buyer's bank account. If the buyer accepts, then the merchant can be authorized (block 406) to be part of the transaction. In this step, the change can be transferred to the buyer, unless the buyer is using the app (or physical card) to purchase from the merchant.

At block 405, the merchant total amount of change, for example, dollars and/or cents, is transferred to the bank is displayed in the form of a digital receipt. A signature or other identification technique may be required for authorization. The merchant may mail the change or otherwise transfer the change to the bank. The receipt can be printed out for the customer's records, and/or the merchant's records, and/or stored at a memory device. The receipt can that show the item that was purchased along with a transaction number. A window tab can be displayed that allows authorization, for example, selecting yes or no. If access is denied, i.e., no is selected, then the method proceeds back to block 4. If access is accepted, then the method proceeds to block 406, where authorization is completed, and a total amount of a checking balance may be given.

At block 407, a window is displayed that shows the total amount of money after the money is transferred to the user's account or the like. The window is closed indicating that the transaction is completed.

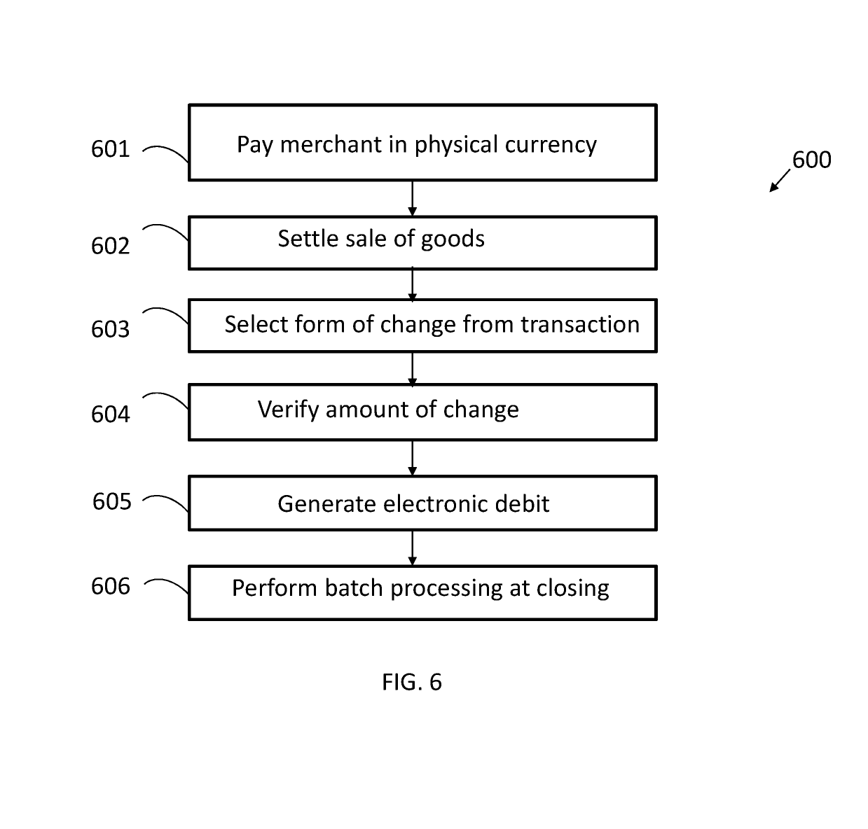

FIG. 6 is a flow diagram of a method for transferring change from a currency exchange to an electronic format, in accordance with some embodiments. Some or all of the method 800 can be performed on one or more devices illustrated in the environment of FIG. 3B.

At block 601, a customer 11 pays a merchant with physical money for a predetermined value of goods at a point of sales (POS) terminal. In the example shown in FIG. 6, the customer pays $2.00 for a $1.75 item.

At block 602, the merchant settles the sale of the goods with a unique transaction ID.

For example, the customer may initiate a cash purchase, whereby a transaction ID number is generated at the payment terminal this transaction ID number for example in alpha numeric form. When the buyer decides to convert currency the swiping of the physical card or scanning of the mobile device records the transaction ID and this information is sent to a computer server that records the transaction details;
ABA# of buyer account
Buyer account number with us
User: user log in information
Merchant transaction ID#
Our own unique Transaction ID# (alpha numeric)
Amount of transaction
Currency type (dollars, euro, etc)
Authorization Code: code sent to merchant bank or acquiring bank once transaction is approved
Batch ID# of transaction
Balance: total balance of customer money conversion transactions
Card Security Code Match: code must match numbers inputted (zip code, pin number) at payment terminal or authorization of mobile device
IP Address: IP address where transaction is taking place
Cost per unit of items purchased
Description: description of item purchased
Device Type: type of device used to initiate transaction
Fee: Fee charged by us to the client (buyer/user)
Transaction Status: approved/deny

At block 603, the customer 11 selects the form of change to be received. Referring to the previous example, the customer 11 may opt to receive $0.25 in hard currency, for example, a quarter, or receive the change in an electronic format, where it can be deposited on a physical card or at a bank account, for example, a store member card, credit card, debit card, account card, and so on.

At block 604, the transfer of the change to the customer 11, e.g., $0.25, is initiated with the generated unique transaction ID that must match the merchant's transaction ID thereby verifying the change amount. A processor may be located at the payment terminal. The merchant ID number is generated using alphanumeric system that records specific information on the particular sale of the item. Accounting is validated by the merchants accountants. The merchant shows total sales based on unique transaction ID# of each transaction. Customers whom elected to not receive physical change back have their transactions recorded on their device and/or account, these transactions must match the debits coming out of the merchants or acquiring bank account. In this case, the merchant keeps the hard change of each conversion transaction but is debited the equal amount from their own account. Another example would be that we have a bank account that credits the buyer the change amount and we later bill the merchant for the transaction that we paid the buyer. This way the merchant always has the appropriate amount of money at the end of the day.

At block 605, an electronic debit is initiated from the merchant account to the customer 11 for $0.25.

At block 606, at the end of the business day, the merchant may initiate a batch close on transactions to establish that a combined set of sales transactions equals the total currency received. The batch close will also show total the electronic debits for customers electing to receive electronic change on their mobile application, physical card, account, and so on. The batch close is located at the site of the merchant transaction. In addition we are also running batch closes on out own transaction details. This occurs at our office on our servers.

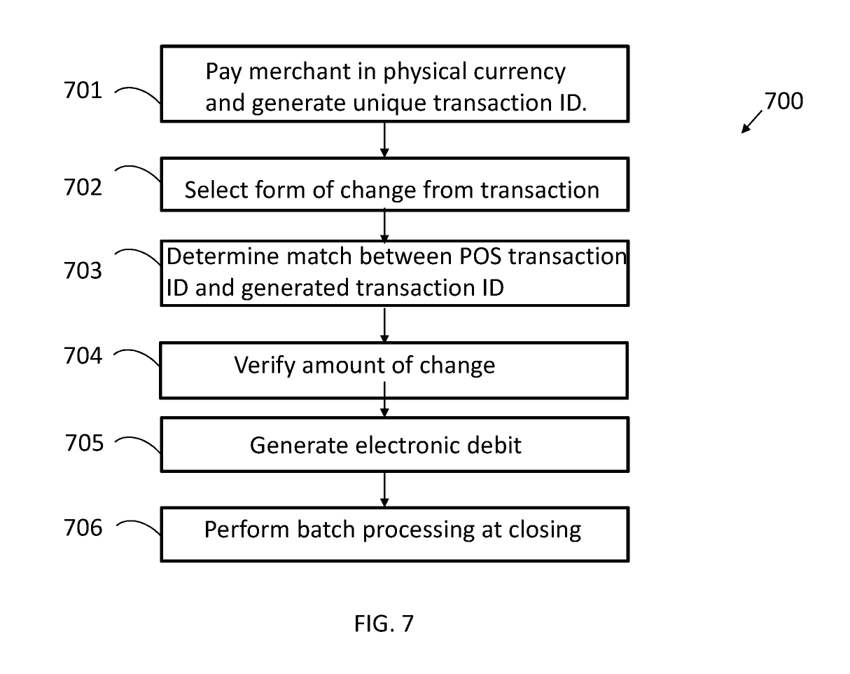

FIG. 7 is a flow diagram of a method 700 for transferring change from a currency exchange to an electronic format, in accordance with other embodiments. Some or all of the method 800 can be performed on one or more devices illustrated in the environment of FIG. 3B.

At block 701, a customer 11 pays a merchant with physical money for a predetermined value of goods at a point of sales (POS) terminal. In the example shown in FIG. 6, the customer 11 pays $2.00 for a $1.75 item. The merchant settles the sale of the goods with a unique transaction ID.

At block 702, the customer 11 selects the form of change to be received. Referring to the previous example, the customer may opt to receive $0.25 in hard currency, for example, a quarter, or receive the change in an electronic format, where it can be deposited on a physical card or at a bank account, for example, a store member card, credit card, debit card, account card, and so on.

At block 703, the customer 11 uses a mobile electronic device such as a smartphone that communicates with the POS terminal. The transaction ID# that is generated at block 701 is determined to match the POS transaction ID#. The POS transaction ID# may be generated at the payment terminal

At block 704, the transfer of the change to the customer 11, e.g., $0.25, is initiated with the generated unique transaction ID that must match the merchant's transaction ID, thereby verifying the change amount.

At block 705, an electronic debit is initiated from the merchant account to the customer for $0.25.

At block 706, at the end of the business day, the merchant may initiate a batch close on transactions to establish that a combined set of sales transactions equals the total currency received. The batch close will also show total the electronic debits for customers electing to receive electronic change on their mobile application, physical card, account, and so on. The batch close occurs on the merchant servers. In addition, an independent batch close may be executed so as to be able to at the end of a day match up and account for all conversion transactions between buyers and merchants

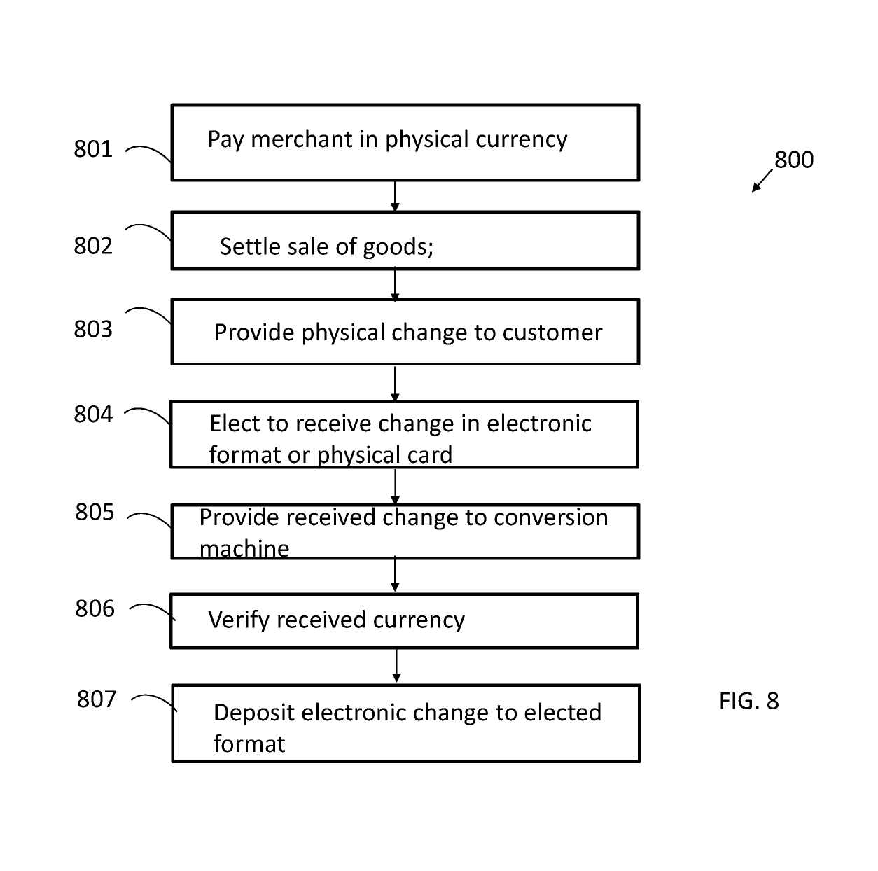

FIG. 8 is a flow diagram of a method for transferring change from a currency exchange to an electronic format, in accordance with some embodiments. Some or all of the method 800 can be performed on one or more devices illustrated in the environment of FIG. 3B.

At block 801, a customer 11 pays a merchant with physical money for a predetermined value of goods at a point of sales (POS) terminal. In the example shown in FIG. 6, the customer 11 pays $2.00 for a $1.75 item.

At block 802, the merchant settles the sale of the goods with a unique transaction ID. At block 803, the merchant also provides the customer 11 with physical change, e.g., $0.25 as a quarter, dimes, nickels, and so on. However, the customer 11 is also provide the option to receive the change in an electronic format, e.g., deposited into the customer's bank account, or provided on a physical card, e.g., a debit card or the like.

At block 804, the customer 11 elects to receive the change in an electronic format or on a physical card. Other options may include a third party account such as a charity, trust, and so on.

At block 805, the physical change (e.g. $0.25) is deposited into the conversion machine 10, for example, by the customer or merchant.

At block 806, the conversion machine 10 communicates to the change verification engine 38 that it has received the change. As described herein, in some embodiments, the change verification engine 38 is part of the conversion machine 10. In other embodiments, the conversion machine 10 and verification engine 38 are standalone hardware devices and communicate with each other via the network 16. After verification that the received currency is valid, a unique transaction ID is generated. The ID is unique because it is generated by the conversion machine 10, or other computer that collects the information, for example, information illustrated in block 602 above.

At block 807, the customer 11 can electronically scans a mobile electronic device such as a smartphone, which stores and executes a currency conversion application. In doing so, the electronic change, $0.25 into the elected account, e.g. bank account, personal card, third party account, and so on. In some embodiments, the customer 11 can scan a bank card or other physical card that can receive credit from the transaction. The customer may direct specific amounts into separate accounts.

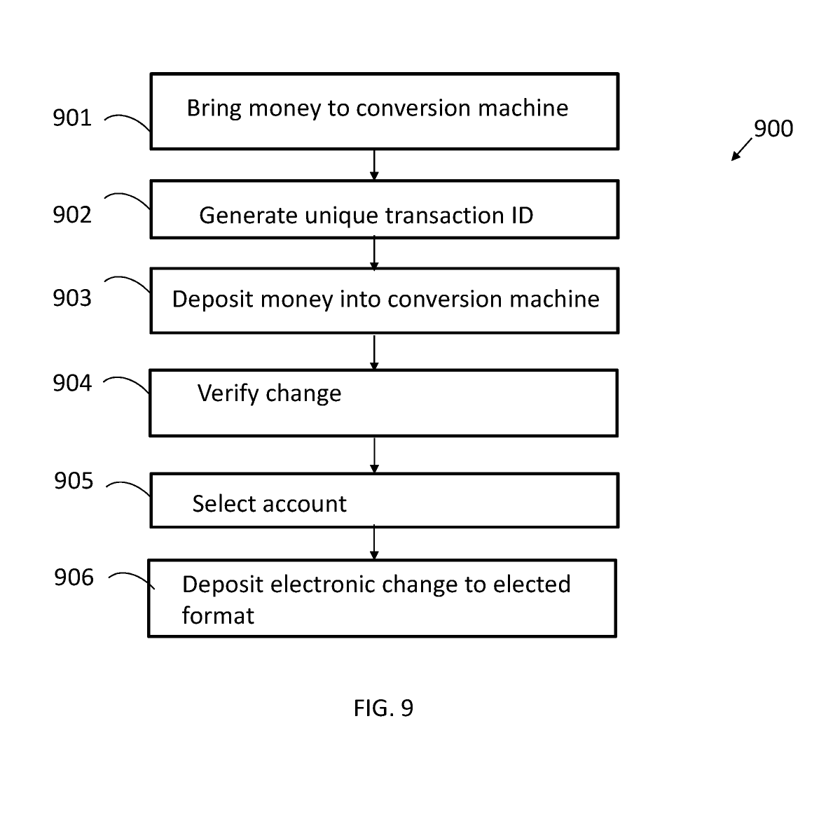

FIG. 9 is a flow diagram of a method 900 for transferring change from a currency exchange to an electronic format, in accordance with other embodiments. Some or all of the method 800 can be performed on one or more devices illustrated in the environment of FIG. 3B.

At block 901, the customer 11 may take miscellaneous change, for example, loose change provided to the customer 11 as change to various purchase, to a conversion machine 10.

At block 902, the customer 11 may scan a mobile electronic device 12 or swipe or otherwise retrieve data from a barcode, QR code, or the like from a physical card. The physical card may include electronic change, for example, provided thereto in accordance with embodiments described herein. A unique transaction ID may be generated. As described herein a transaction ID can be used to verify that the person depositing currency is the same person that will receive the converted money, for example, money converted into a format that is placed on a physical card, bank account, and so on. A comparison between transaction IDs can be used to ensure that the tracking system is able to track potential fraud by individuals attempting to use fake currency.

At block 903, the customer may deposit the change into the conversion machine 10.

At block 904, the conversion machine 10 verifies the currency and matches the unique transaction ID. The transaction ID is compared to a transaction ID generated when the customer initiated a conversion transaction. This ensures that the initiator of the conversion transaction is the same person who deposited the currency after verification. The currency is verified by weights of each currency type 25 cents, 10 cents, etc, also is verified by size or physical composition.

At block 905, the customer 905 may choose on a mobile device 12 or on the screen on the money conversion machine 10 a bank account to deposit the converted funds. The account may be personal such as a bank account, or it can also be directed toward s a third party account such as a charity). The customer can also receive credited funds onto a physical card

At block 906, the transaction is completed.

As described herein, systems and methods in accordance with some embodiments may disrupt or otherwise create an imbalance with respect to a total cash register balance, for example, at the end of a business day, shift, or other relevant period of time. For example, the merchant may have $2.00 from the purchase of a cup of coffee that costs $1.75, while the customer received electronic change, for example, $0.25. However, the merchant also has $0.25 of the $2.00, creating an imbalance. Physical cash can accumulate over time and must be subsequently catalogued and separated. Because the total amount of money that is added to a cash register through an application conflicts with the sum of money being received through regular cash purchases, the inventive concepts in accordance with some embodiments address this issue.

In some embodiments, a merchant cashier shifts in a unique sales slip allowing a manager or other associate to review balances of transactions involving the cashier. For example, the cashier is able to print out all transactions that involve the conversion of physical change. The sum of the values involved in these transactions can be checked at the end of the day to reconcile the cashiers shift. These transactions must be matched up with corresponding unique transaction IDs, for example, described above.

In some embodiments, a process is provided where the merchant holds the customer's money (from purchases made) to later give back through EFT (electronic fund transfer) and online banking , which must be specified and named . This process may be referred to as CET (Cents express Transfer). An application stored at and executed on a customer electronic device, e.g., smartphone, laptop computer, and so on, and generating data read by the merchant's POS may be referred to as a Cent Express (CE) application and is hard wired to each register in use. All transactions used with the CE application is totaled at the end of the cashier's shift in its own unique sales slip .and allowing the manger to check the cashier balances.

When the merchant has the information of total amount money generated through The CE application, for example, by reading the sales slip, the merchant's computer can therefore calculate and check the difference between the total amount of money received form normal cash transactions and cashed accumulated with CE coin application and separate them to a safe or other location of safekeeping, and therefore allowing the register to be reset to the starting amount for the next shift at the merchant's business. The money generated from the CET is stored into a safe.

With regard to the excess change, the buyer has $0.25, and also the merchant has the extra $0.25. The buyer may receive the change in a subsequent transaction, for example, provided to the customer's account. Similar to a refund that takes 2-3 business days, the $0.25 in electronic format is to be returned to the buyer is a number that will later be fulfilled. That way the merchant does not have an extra $0.25. The physical change, i.e., $0.25, is available for the merchant while the customer also received an equivalent electronic value of $0.25. The foregoing refund process prevents the duplication of change, i.e., an electronic change value to the customer; a physical change to the merchant.

Credit cards and smart phone applications are well-known vehicles for paying for products to merchants. Due to their popularity, there has been a corresponding drop in use of physical currency, i.e., dollars and cents, to perform commercial transactions. This is particularly true when providing donations to charities or the like. In some special cases, physical money is provided, for example, providing change to a homeless man. However, in many other cases, a credit card is typically used. For example, credit cards may be used for quick donations at a register or at a digital donation box.

However, there is an interest in donate the change from a commercial transaction to a charity or the like. The problem with donating with change is that fewer people carry loose change around due to the popularity of digital currency, for example, Apple Pay™ service, and credit or debit cards. The chance of donating change to a charity box or digital donation box is also based on the user's ability to find and use a donation or charity box or kiosk. And when a customer or user finds a charity box to give left over change the user has few available options. Most kiosks have a small selection to choose form and charity boxes are governed by an organization or merchant, who in turn chooses the receiver of the donation, such as a particular foundation.

In some embodiments, a change donation application is provided and executed on a mobile electronic device for communicating with special purpose computers so that the user is no longer limited to a small amount of selected charity events. Here, the user is empowered to make a difference in a own unique way and in a user-defined amount. The change donation application permits the user to provide physical or electronic change, for example, generated according to a method described in an abovementioned embodiment, to a donation box that stores or generates for providing to a storage device a digital record of the amount entered and selected charity organization. The user may receive a receipt, for example, a printed paper receipt or a digital receipt sent by email, text, or other electronic communication to an electronic device of choice.

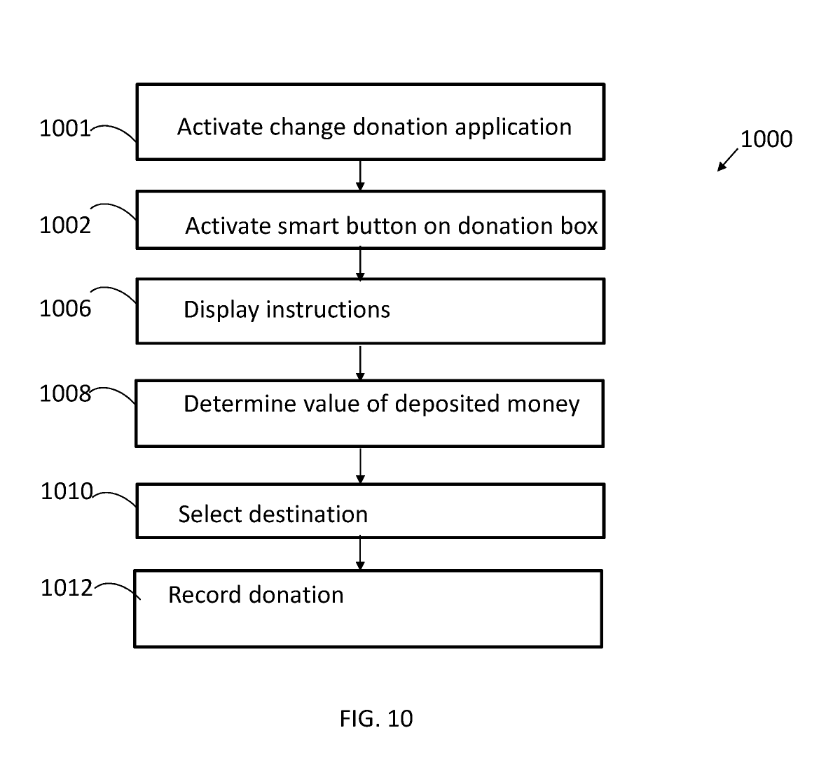

FIG. 10 is a flow diagram illustrating a donation exchange 1000, in accordance with some embodiments. Some or all of the method 800 can be performed on one or more devices illustrated in the environment of FIG. 3B.

At block 1002, a change donation application is activated. The change donation application may, in some embodiments, execute according to method 100 illustrated at FIG. 1. In other embodiments, the change donation application may be provided and executed according to one or more methods described in an abovementioned embodiment.

At block 1004, a button or the like on a digital donation box 50 may be activated, for example, pressed by a user. In some embodiments, the digital donation box 50 is activated electronically, for example, by an electronic signal generated at the user's mobile electronic device 12. The digital donation box 50 may include elements of the converter 10 described herein, for example, a display, input, and so on. The digital donation box 50 may be part of a kiosk or the like.

At block 1006, in response to the activation of the digital donation box 50, a display screen on the digital donation box 50 displays instructions to the user for depositing physical currency, for example, change, into a slot or the like in the digital donation box.

In this example the change that is deposited is converted to digital change (the donation) which is then allocated to a foundation of choice. We collect the change and we initiate the digital transaction to the foundation of choice (the person putting the change in the machine elects what foundation), the person is also able to track what donations have been given to what foundations on the app in order to get a tax rebate at the end of the year.

In some embodiments, the donation box can also read the users data via phone and finds its priority list for donation so that the user does not have to input the donation selection manually. The donation app also shows a graph which visually represents its popularity through graphs and statistics.

The display can present on the screen the amount of money deposited (physically or electronically). Other information may be displayed such as a desired, minimum, or maximum amount of donation value, accumulated or total amount of donation value for a particular charity or other like, total amount of change entered to the digital donation box 50, and so on.

At block 1008, the digital donation box 50 reads and counts the total amount of change entered. The display may include a window that displays the deposited amount. Another window may display the latest donation in the area along with the most popular to choose form. Each selection has a description.

At block 1010, the user chooses which donation to choose form and also the amount he wants. The user is also giving the option to divide the amount of change to be allocated to separate donations.

At block 1012, once the selection is done the digital donation box 50 reads the application executed on the user's electronic device 12. The donated amount is recorded at a storage device.

Once the user has chosen his own selection and amount of change to donate, the amount is finalized by pressing a button on the screen. A receipt is generated in a digital form as a digital or electronic document, which is emailed to the user's phone, or more specifically, an application on the phone. This digital receipt can later be used for a tax break. The display window can display a window, text, graphic, or the like indicating that the exchange is completed, and can include other information such as a thank you message for helping the needed.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A method for performing a financial transaction, comprising:
processing a physical tradeable asset having a value that is greater than a value of the good or service being purchased with the financial instrument;
electronically depositing at a storage device change from the asset corresponding to a difference between the value of the physical tradable asset and the value of the good or service being purchased.

2. The method of claim 1, wherein the tradeable asset includes cash or other tangible exchangeable currency.

3. The method of claim 1, further comprising reconciling a receipt of the difference in the form of electronic change to a customer and the difference in the form of physical cash to a merchant, including:
temporarily holding by the merchant the physical tradeable asset;
collecting data related to the transaction at an application stored and executed at a mobile electronic device;
processing the data at a point of sale system that includes information regarding the physical tradeable asset and the difference between the value of the physical tradable asset and the value of the good or service being purchased;
comparing the difference between the total amount of money received form normal cash transactions and cashed accumulated with application; and
providing to a financial institute the temporarily held difference between the value of the physical tradable asset and the value of the good or service being purchased, wherein a merchant cashier shifts in a unique sales slip, allowing the manager to check a cashier balance.

4. The method of claim 3, wherein a cashier shifts in its own unique sales slip allowing the manager to check the cashier balances, wherein all transactions pertaining to a conversion of physical change to an electronic equivalent value are reconciled by comparing unique transaction identifiers with a total value of the transactions.

5. The method of claim 1, further comprising:
providing physical change to a conversion machine;
scanning a mobile electronic device or swiping a code from a physical card that is configured to store a monetary value;
verifying by the conversion machine the received physical change comparing transaction identifications (ID);
selecting a bank account to deposit the converted money; and
depositing the converted money on the physical card.

6. The method of claim 1, further comprising:
executing an application on an electronic device, wherein in response the application displays a list of financial institutions for directing the electronically deposited change;
selecting at a user interface of the electronic device a merchant authorized to access a selected financial institution of the list of financial institutions; and
automatically transferring the change electrically from the merchant's account to the selected financial instruction.

7. The method of claim 6, wherein the merchant displayed according to location relative to the electronic device.

8. The method of claim 6, further comprising sending the physical change from the merchant to the financial institution for reconciling the physical change and electronic change.

9. The method of claim 1, further comprising:
providing a merchant with the physical tradable asset having the value;
setting, by a merchant computer, a sale of the good or service with a unique transaction ID;
recording the transaction including the transaction ID;
selecting a form of the change to be received; and
transferring the change to the customer, wherein the change amount is verified by matching the generated unique transaction ID with a merchant's transaction ID.

10. The method of claim 9, wherein the merchant initiates a batch close on transactions to establish that a combined set of sales transactions equals the total currency received.

11. A conversion machine, comprising:
a money collection input for receiving a deposited amount of a physical cash;
a storage device for temporarily storing the received physical cash; and
a conversion processor that converts a value of the received physical currency to a digital value.

12. The conversion machine of claim 11, further comprising an output device that outputs the digital value to a communications network for receipt by an account holder or digital application.

13. A method for donation exchange, comprising:
activating a change donation application at an electronic device having a display;
activating a digital donation box;
depositing physical cash into the digital donation box in response to an instruction displayed at the display of the digital donation box;
processing at the digital donation box the received physical cash to determine a value of the received cash;
displaying options at the digital donation box for donating the received physical cash;
and providing the physical cash or an electronic equivalent of the physical cash to the selected donation recipient.
